(19) United States
(12) Patent Application Publication
(10) Pub. No.: US 2010/0327603 A1
(43) Pub. Date: Dec. 30, 2010

(54) D.E.S. generator 2

(76) Inventor: Dale E. Suaan, Marlton, NJ (US)

Correspondence Address: Dale E. Suaan, 31 N. Maple Ave. Apt. # 44, Marlton, NJ, 08053, US

(21) Appl. No.: 12/459,217

(22) Filed: Jun. 26, 2009

(51) Int. Cl. F03G 5/06

(52) U.S. Cl. 290/1 R

(57) ABSTRACT

D.E.S. GENERATOR 2, an electricity-generating System consisting of a plurality of mechanical devices for producing and transmitting rotary motions; connecting instrument for transferring said rotary motions; means for engaging said connecting instrument; mechanical device for converting mechanical energy into electrical energy; and an unconventional means for spinning said mechanical devices for producing and transmitting rotary motions which make said mechanical device converting mechanical energy into electrical energy generate electricity. Said unconventional means not being any kind of fossil fuel, nor water, nor wind, nor solar power but, nevertheless, is capable of doing what water or wind can do, and is readily available, inexhaustible, renewable and sustainable. Unlike the wind and solar power, however, it does not depend on nor is affected by any kind of weather conditions. Thus, it is reliable and can make the D.E.S. Generating System generate electrical energy continuously. Said D.E.S. Generating System can be designed to continuously generate several giga-watts of clean electrical energy.

### CROSS-REFERENCE TO RELATED APPLICATION

This application is a modification of a related patent application Ser. No. 09/161,963 entitled “D.E.S. Generator” filed last Sep. 28, 1998.

### STATEMENT REGARDING FEDERALLY-SPONSORED RESEARCH AND DEVELOPMENT

The U.S. Federal Government has been sponsoring, energy-related researches and renewable energy projects to solve the problem of emission and to reduce importation expenses on fossil fuels. In spite of the millions of dollars of Federal funding, not much have been accomplished in the field of electricity-generation. Triggered by the current Economic crisis, more emphasis has been given to Wind power and Solar energy, in spite of their limitations. In America as well as in other parts of the world, there is still so much reliance on fossil fuels for electricity-generation that the problem of emission still remains to be solved. This invention hopes to address the current problem.

### REFERENCE TO “MICROFICHE APPENDIX”

Not applicable

### BACKGROUND OF THE INVENTION

1. Field of Invention

This invention has something to do with electricity generation primarily for residential, commercial and industrial purposes. It provides a solution to the problem of lack of energy and an alternative to fossil fuels which produce pollution, cause global warming and destroy the environment.

2. Description of Related Arts including Information Disclosed Under 37 CFR 1.97 and 1.98

Currently, electricity-generating systems make use of either fossil fuels, natural gas, water, geothermal power, wind power or solar energy. Those that use fossil fuels, like coal, gasoline or diesel fuel, produce emission that causes global warming. And these resources are exhaustible and cost so much to import.

Since its invention, electricity has helped bring about tremendous economic, industrial, scientific and technological progress. It plays a very important role in human life. In the process of generating electricity, however, the earth and mankind it is supposed to benefit are gradually being destroyed, because of the pollution being produced. Thus, it is imperative that alternative electricity-generating systems which can produce clean and cheaper energy should be found.

### SUMMARY OF THE INVENTION

D.E.S Generator 2, which stands for Dale E. Suaan Generating System # 2, is a simple Electricity-Generating System which can generate megawatts of electricity. It can, however, be designed to generate even gigawatts of green energy. But, unlike other existing Electricity-Generating Systems, it does not use any kind of fossil fuel, nor water, nor wind. In stead, it utilizes an unconventional means to rotate a Generator's drive-shaft to make it generate electricity. And this unconventional means, fortunately, is everywhere, readily available, inexhaustible, renewable and sustainable. Surprisingly, however, no one has ever thought of exploiting it or using it for electricity generation, like the wind and water. It not only can do what wind and water can do, but it can work even better than the wind or water. It is because it is not affected by weather conditions and it does not depend on Mother Nature. And this unconventional means is no other than human power, provided by live human beings. Several people, hired to work by shifts for about 30 minutes to 1 hour per shift, can easily spin, as the wind and water do, the huge wheel-turbines to produce sufficient horse power to drive the generator of the D.E.S. Generating System to make it generate electricity according to its specified output. The number of people employed to spin the wheel-turbines is determined by the number of wheel-turbines being used. And the number and size of the wheel-turbines used are determined by the amount of torque needed to match the horse power required to drive the generator used according to its specified output. Huge wheel-turbines, when properly designed, are not only easy to spin, but can also produce high torque or so much horse power capable of matching the requirement of a high-output generator. And with so many ready and capable hands to hire, it will make the work of spinning the wheel-turbines even easier and lighter and, consequently, the generation of clean energy.

### OBJECTS AND ADVANTAGES

Accordingly, several objects and advantages of this invention are:
1. The D.E.S. Generator 2 is a simple generating system that has few parts, easy to build, and can be installed even in empty big warehouses or spacious enclosed structures within a City or Township.
2. Although it is simple, it can be designed to generate even gigawatts of electricity.
3. It does not use any kind of fossil fuel, thus it generates clean energy and prevents global warming.
4. Its unique design calls for the employment not just of hundreds but thousands of workers and it does not require special skill or a Diploma.
5. Unlike the Wind Turbines, Solar Panels, Hydro-electric Generating Plants and Nuclear Plants, it is much cheaper to build and poses no environmental concerns.
6. It saves the billions of dollars spent on importation of fossil fuels and on building of the aforementioned expensive Electricity-generating Systems.
7. It eliminates dependence on fossil fuels and servitude to those who produce and control these exhaustible sources of energy.
8. Wind Turbines work only if there is wind, and Solar Panels only when the sun is shining. But the D.E.S Generator 2 can generate electricity continuously because it does not depend on weather conditions.
9. The D.E.S. Generating System gives every City an opportunity to have its own Electricity Generating Plant and to provide employment to its own residents.
10. People hired to work in the D.E.S. Generating Plants are not only given permanent employment, but are also provided the opportunity to “work out” (which is good for their health), while earning a living.

Further objects and advantages of this invention will become apparent from the consideration of the drawing and ensuing descriptions.

### BRIEF DESCRIPTION OF THE DRAWING

FIG. 1 is a perspective view of the D.E.S. Generator 2 and its components.

### DETAILED DESCRIPTION OF THE INVENTION

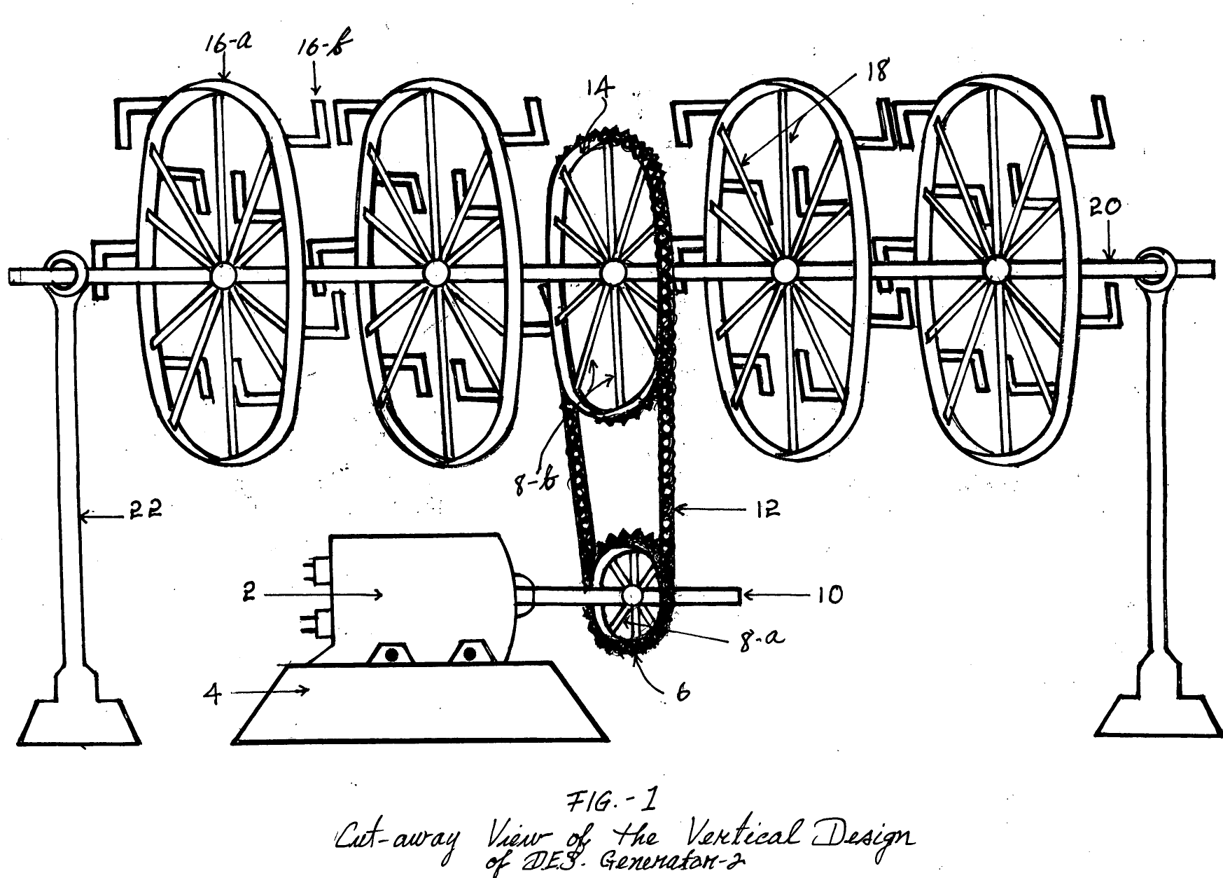

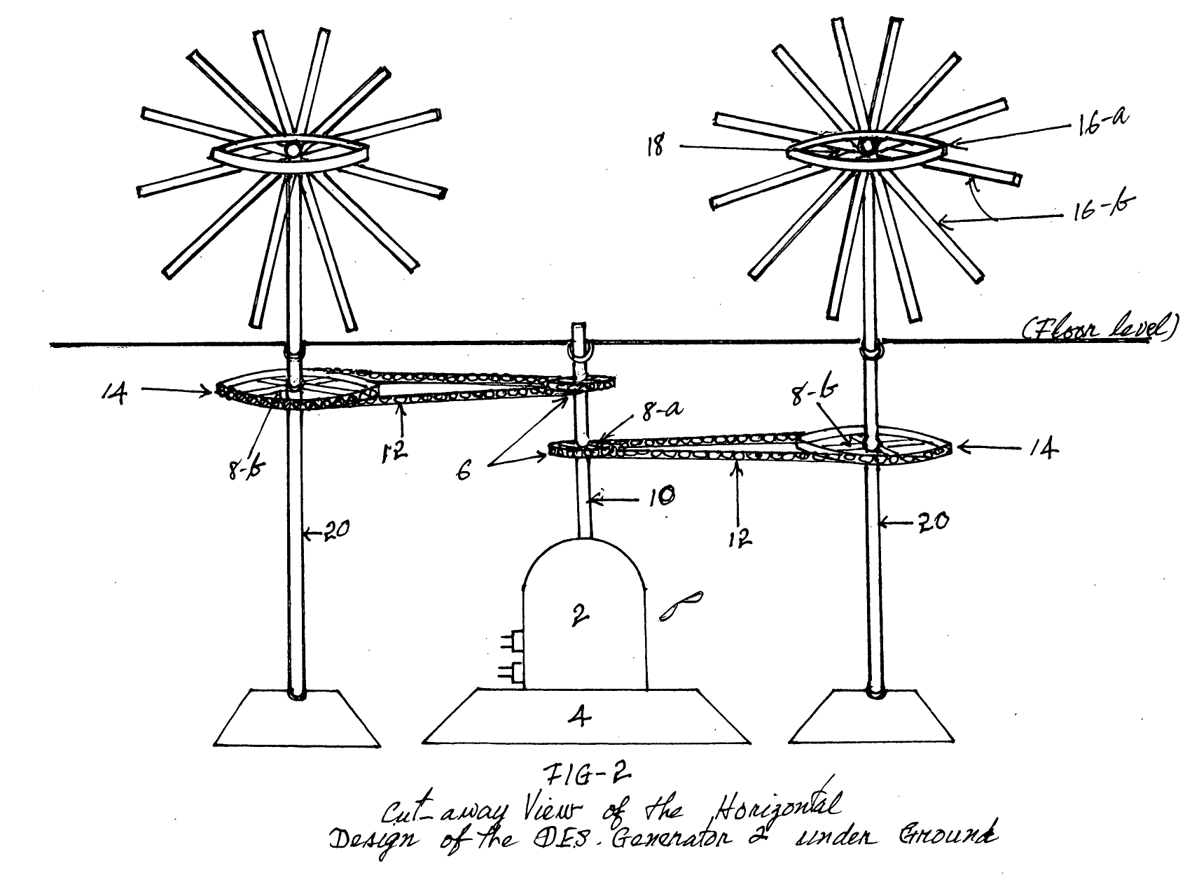

Reference Numerals in Drawing (FIG. 1)
2=Generator head with AC output and a capacity to generate megawatts of electricity. Like the huge Wind Generators, the D.E.S. Generators have slow revolution per minute (RPM), making it possible for their drive-shafts to be spinned easily by several Wheel-turbines.
4=Concrete stand which secures the Generator head in place.
6=Small sprocket-wheel with centered hub securely attached to the generator's drive shaft.
8-a=Spokes extending from the inner rim to the hub of the small sprocket-wheel that is attached to the drive-shaft.
10=The drive-shaft which rotates the rotor of the generator head to make it generate electricity.
12=Chain for transferring rotary motion from the big sprocket-wheel to the small procket-wheel.
14=The big sprocket-wheel with centered hub securely attached to the common shaft of the wheel-turbines and rotates with the wheel-turbines when these are manually spinned.
8-b=Spokes extending from the inner rim to the hub of the big sprocket-wheel.
6-a=A series of wheel-turbines, with each individual wheel-turbine having a diameter ranging from 10 to 30 feet or more, depending on the need. The number of the wheel-turbines needed and their sizes are determined by the amount of torque needed to match the horse power required to spin the drive-shaft of the generator being used according to its specifications.
16-b=Wheel-turbine handles. Each wheel-turbine is provided with a series of handles attached to the right and left sides of each wheel to facilitate the manual spinning of each wheel by at least 3 individuals.
18=Spokes extending from the inner rim to the centered hub (of each wheel-turbine) that is securely attached to the common shaft.
20=Common shaft securely attached to the centered hub of each wheel-turbine and rotates with the wheel-turbines when these are being manually spinned. This common shaft is being held, suspended in the air, by posts or supports in such a way that it can rotate freely whenever the wheel-turbines are being spinned.
22=Posts that hold the common shaft of the series of wheel-turbines.

### The Process in the Operation of the Invention

In the Hydro-electric Generating System, all that water does, with its force and continuous flow, is to spin the water-turbine which rotates the drive-shaft of the generator being used to make it generate electricity. In Wind Generating System, the wind also spins the wind-turbines which drives the generator. In the D.E.S. Generating System, the drive-shaft of the generator is being rotated by a series of huge wheel-turbines by means of a chain and two sprocket-wheels. The wheel-turbines, however, are being spinned not by water nor wind nor steam nor any kind of fossil fuel but manually by several people. When the wheel-turbines are being spinned, the big sprocket wheel, firmly and securely attached to the common shaft of the wheel-turbines, transfers by means of a chain the rotary motion to the small sprocket-wheel that is firmly and securely attached to the drive-shaft of the generator head. As the wheel-turbines spin continuously, so are the common shaft, the big sprocket-wheel, the chain, the small sprocket-wheel and the drive-shaft of the generator head, simultaneously and continuously, thus, making the generator head generate electricity continuously.

In the D.E.S. Generating System, “the energy in some form” being used to drive the D.E.S. Generator in order to make it generate electricity continuously is different from the energy which is generated by the D.E.S. Generator. The energy source does not come from itself but from another source—from live human beings which provide the human energy or human power. Thus, the energy being generated cannot be “used up by the machine” that is generating said energy. This invention, therefore, cannot be considered as contradictory to the Law of the Conservation of Energy nor as inoperative. Consequently, the invention is feasible and operable.

### Alternative Embodiment

Although the invention has been described in this Specification with reference to embodiments as having specific design and components or as having many specificities, these should not be construed as limitations on the scope of this invention, but rather as an exemplification of one preferred embodiment thereof. It is understood that these embodiments are given only as examples. Other variations, configurations, modifications and changes arepossible, provided they do not depart from the scope of the Patent Claims attached below. Accordingly, the scope of this invention should be determined not only by the embodiments illustrated or examples given, but also by the appended Claims and their legal equivalents.

I claim:

1. An Electricity Generating System called D. E. S. GENERATOR 2 comprising:
a. a machine converting mechanical energy into electrical energy; said machine of claim 1 being a Generator for generating electricity.
b. a connecting instrument for transferring motion; said connecting instrument of claim 1 being a chain for transferring rotary motion from the big sprocket-wheel to the small sprocket-wheel firmly attached to the drive-shaft of said Generator;
c. means for engaging the links of a chain; said engaging means of claim 1 being sprocket-wheel rimmed with a plurality of tooth-like projections to engage the links of said chain transferring the rotary motion.
d. devices transmitting rotary motion; said devices transmitting rotary motion of claim 1 being a plurality of sizable wheel-turbines arranged horizontally and securely fastened to a long common shaft rotating with said wheel-turbines when these are being spinned;
e. an unconventional means for spinning said devices transmitting rotary motion; said unconventional means of claim 1 being human power for spinning said devices transmitting rotary motion, provided by live human beings;
Whereby, the D.E.S. Generating System is able to generate electricity continuously, when said unconventional means continuously generate torque by spinning said sizable wheel-turbines which rotate the drive-shaft of said Generator being used.
